(19) United States
(12) Patent Application Publication
(10) Pub. No.: US 2012/0209826 A1
(43) Pub. Date: Aug. 16, 2012

(54) METHOD AND APPARATUS FOR PROVIDING LOCATION BASED INFORMATION

(75) Inventor: Petros Belimpasakis, Tampere (FI)

(73) Assignee: Nokia Corporation, Espoo (FI)

(21) Appl. No.: 13/025,121

(22) Filed: Feb. 10, 2011

(51) Int. Cl. G06F 17/30

(52) U.S. Cl. 707/710; 707/E17.108

(57) ABSTRACT

An approach is provided for providing location based information according to a predetermined format. A location information manager associates location information with web content. The location information manager also causes, at least in part, publication of the web content and the associated location information according to a predetermined format, wherein the predetermined format facilitates, at least in part, discovery of the location information.

### BACKGROUND

Service providers and device manufacturers (e.g., wireless, cellular, etc.) are continually challenged to deliver value and convenience to consumers by, for example, providing compelling network services. Mobile devices with various methods of connectivity are now becoming the primary gateway to various services provided via the Internet and also a major storage point for information. As the scope and variety of the available services (e.g., applications) increases, interoperability and combined use of these services becomes a major challenge. One example of service aggregation is providing location based information via mobile devices. In recent years, several services have become available that provide different types of location based information to the users of mobile devices. By way of example, these services utilize camera equipped mobile devices as platforms for providing information to the user. Some of the examples of location based services include augmented reality, augmented virtual reality, mapping, navigation, etc. Historically, these services implement service-specific servers (e.g., on the Internet) that provide service-related information (e.g., location-based information such as augmented reality information). Moreover, these services also typically rely on customized independent client applications that often do not interoperate with more than one service, thereby requiring users to many different client applications to access the different services. Accordingly, service providers and device manufacturers face significant technical challenges to providing interoperability of location-based information across different service and/or content providers.

### Some Example Embodiments

Therefore, there is a need for an approach for providing location based information according to a generally accessible format.

According to one embodiment, a method comprises associating location information with web content. The method also comprises causing, at least in part, publication of the web content and the associated location information according to a predetermined format, wherein the predetermined format facilitates, at least in part, discovery of the location information.

According to another embodiment, an apparatus comprises at least one processor, and at least one memory including computer program code, the at least one memory and the computer program code configured to, with the at least one processor, cause, at least in part, the apparatus to associate location information with web content. The apparatus is also caused to cause, at least in part, publication of the web content and the associated location information according to a predetermined format, wherein the predetermined format facilitates, at least in part, discovery of the location information.

According to another embodiment, a computer-readable storage medium carries one or more sequences of one or more instructions which, when executed by one or more processors, cause, at least in part, an apparatus to associate location information with web content. The apparatus is also caused to cause, at least in part, publication of the web content and the associated location information according to a predetermined format, wherein the predetermined format facilitates, at least in part, discovery of the location information.

According to another embodiment, an apparatus comprises means for associating location information with web content. The apparatus also comprises means for causing, at least in part, publication of the web content and the associated location information according to a predetermined format, wherein the predetermined format facilitates, at least in part, discovery of the location information.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing location based information according to a predetermined format, according to one embodiment;

FIG. 2 is a diagram of the components of location information manager, according to one embodiment;

FIG. 3 is a flowchart of a process for providing location based information according to a predetermined format, according to one embodiment;

FIGS. 4A-4B show architectures of exemplary location based information providers, according to one embodiment;

FIG. 5 shows the representation of a site indicator for a location based information provider on a web browser, according to one embodiment;

FIGS. 6A-6C show displaying of location based information layers and content on a device screen, according to one embodiment;

FIG. 7 shows results of a search for location based information providers, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for providing location based information according to a predetermined format are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term location information or location based information refers to any information representing a location (e.g., a point, a path, an area, etc.) on a map, an image, a design, a photo, a graph, etc. or a combination thereof. Although various embodiments are described with respect to geographic locations (e.g., street views, camera feed), it is contemplated that the approach described herein may be used with other location information as described. Although, in what follows, the features of the invention are discussed with regards to Augmented Reality (AR) services for providing content related to camera feeds of mobile devices, as an example embodiment, it is contemplated that the discussed features are easily applicable to other location-based services and/or information such as Augmented Virtual Reality, mapping services, navigation services, image processing and interpretation services, etc., or a combination thereof.

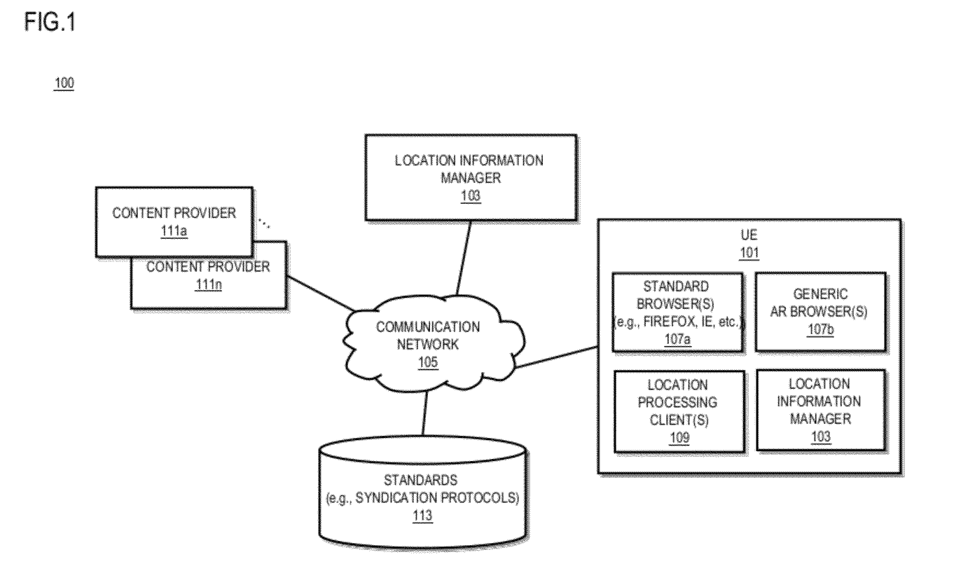

FIG. 1 is a diagram of a system capable of providing location based information according to a predetermined format, according to one embodiment. In recent years many services for providing location based information to the users of mobile devices have been introduced. These services utilize location information, mostly provided by camera equipped mobile devices, for providing content associated with locations to the user. One example of these location based services is Augmented Reality (AR). AR services provide live direct or indirect view of physical, real-world environment whose elements are augmented by virtual sensory input, such as information about the real-world elements. Virtual information about the environment and the objects in it can be stored and retrieved as an information layer on top of the real world view. Typically, a mobile augmented reality client (which is an application running on a mobile phone) communicates with a server (e.g., on the Internet) for getting location-based information (such as points-of-interest, related Wikipedia articles, etc.) and displaying them to the user, at the appropriate locations and orientations. However, historically, each content provider develops and launches its own client using its preferred format, language, and/or software. For example Wikitude® is a mobile AR system developed using the Augmented Reality Markup Language (ARML®) which is a specification language that enables content developers to create content that is displayed on Wikitude® specific AR browsers.

By way of example, a location based content provider, such as an AR provider, can provide content for the user, at a given location and time, from content sources, by filtering out the irrelevant content. For example, a user standing in the middle of a street, may be interested in finding nearby McDonald's stores, via augmented reality view. Traditionally, a developer may create a stand-alone AR client application specific the content of interest. For example, stand-alone AR applications may have relevant information (e.g., all McDonald's restaurants) in their local databases. The user then typically executes the stand-alone AR application that is applicable to the content the user is interested in (e.g., a McDonald's specific AR application to find McDonald's restaurants, or a coffee shop specific AR application to find a coffee shop).

However, having content specific applications can become problematic, as users may not previously know their future needs to download proper applications for them beforehand and looking for domain specific applications (e.g., via an app store) at the time of need is not convenient. Furthermore, users with multiple interests in various content types, will often have to download a separate application for each content type; for example, one for restaurants (if not one for each restaurant chain), one for libraries, one for movie theatres, etc. An example of such applications is Yelp®, a restaurant guide AR provider that provides its own AR application, wherein the Yelp® application operates in connection only with its own servers and content sources.

In some examples, AR providers may provide more general location-based information, but access to this information is nonetheless limited to specific client applications accessing service-specific servers. Examples of this type of AR provider include Layar® Reality Browser, Wikitude®, Nokia's Point&Find®, etc. each having its own specific AR browser, information format, etc. In other words, even under the Integrated Augmented Reality approach taken by these services, these services and their client applications still generally use communications with service-specific servers (e.g., Layar® servers, Wikitude® servers, etc.) and do not interoperate with other services and/or content providers. For example, the contents provided by these services cannot be generically accessed and provided to the user by a general AR browser application (i.e., a generic or standard AR browser application that can be used with the content provided by various AR providers), or by general (standard) browser applications such as Internet Explorer®, FireFox®, etc. As discussed, this is because each provider has its own specific server and provides content in its independently selected format. Therefore, there is a need for standardized contents based on a common format and AR browsers that allow different content from the Internet to be pushed (by content providers) to the user's AR view.

To address this problem, a system 100 of FIG. 1 introduces the capability to provide location based information according to a predetermined format. In the system 100 of FIG. 1, the location information manager 103 enables the location processing clients 109 of the UE 101 to use one or more standard browsers 107a, one or more generic Augmented Reality browsers 107b or a combination thereof, for accessing the location based contents provided by any provider 111a-111n via a location information manager 103, wherein the browsers 107a and 107b do not require to be linked to any specific AR server.

As shown in FIG. 1, in various embodiments, the location information manager 103 may be physically located inside each UE 101 or anywhere else within the reach of UE 101 via the communication network 105. In any case, whether the location information manager 103 is a component of the UE 101 directly communicating with content providers 111a-111n, or the location information manager 103 is a component outside the UE 101 but accessible by UE 101 via the communication network 105, utilization of location information manager 103 eliminates the need for each content provider to have its own specific server to communicate with the UE 101. In other embodiments, the location information manager 103 can be implemented as a component of a browser 107a or 107b.

In one embodiment, the location information manager 103 enables a browser 107a or 107b to communicate with various content providers 111a-111n, and the content providers 111a-111n to advertise their AR information (e.g., AR layers or worlds) in such a way that the browser 107a or 107b is able to discover them, in a machine readable way, and present them to the user of UE 101. For example, a content provider 111a-111n may advertise their services on their own websites and make them available to be discovered by search engines. This makes the discovery of AR layers easy for the user, because the user will not have to access a specific solution directory (e.g., Layar or Wikitude directory) for discovering AR layers or worlds, but those AR layers and worlds are mapped to the well known and widely used URLs of web services. For example, the layer of shopping related content (e.g., service points and stores) can be available from a shopping website, http://www.shopping.com/. Similarly, the layer of ATM addresses of a bank B or the layer of restaurant reviews provided by a restaurant AR provider such as Yelp can be presented at their websites.

As shown in FIG. 1, the system 100 comprises user equipment (UE) 101 having connectivity to the location information manager 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

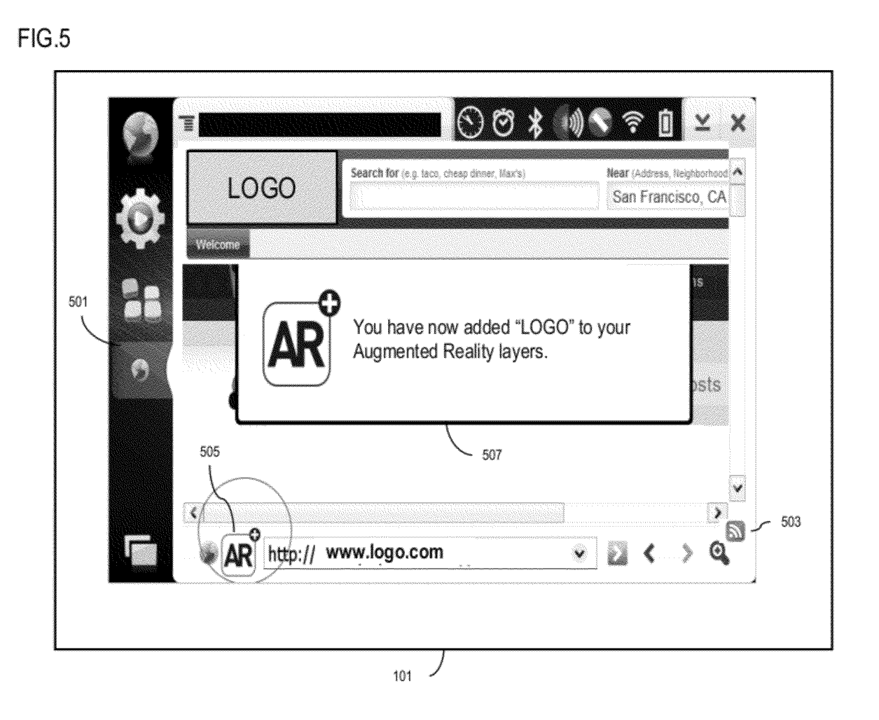

Typically, a content provider 111a-111n may advertise its content by including a specific feed for the content into its website and adding a link to its standard web page. For example a content provider 111a-111n may add the following HTML command to its website: <link href=“/news.atom” rel=“alternate” title=“News Feed” type=“application/atom+xml”> The above HTML command allows a web browser 107a or 107b, to understand that there is a web feed associated with the specific web page, and present it to the user by displaying an icon (e.g., RSS icon) on the browsed website. For example, in FIG. 5 browser 107 shows a display 501 including a special web feed icon 503. The user of UE 101 can subscribe to the provided feed by clicking on icon 503.

In one embodiment, a content provider 111a-111n can simply advertise its AR layers on its respective web pages, for example by providing extensions in the HTML headers of its web pages, similar to the way it may advertise its related web feeds (e.g., RSS, Atom, etc.) feeds. Subsequently, the location information manager 103 enables a user of UE 101 to discover AR layers.

In another embodiment, the user of UE 101 may use a standard web search engine (e.g., Google, Bing, etc.) and search for the desired AR layers, such as “Bank B's ATM locations”. This search via a search engine and managed by the location information manager 103 can bring up a link to the bank B's website (e.g., http://www.B.com) with an indication that this address includes an AR layer. The user can simply bookmark the address and save it on his UE 101 layer bookmark list for further use, subscribe to the AR service, etc.

In yet another embodiment, the user of UE 101 may use a standard web browser 107a available on UE 101 and directly visit the website of his desired AR provider (e.g., http://www.B.com) via the UE's web browser 107a. Upon visiting the address, a special icon may be displayed indicating the existence of an AR layer at the address, similar to the way feed icons (e.g., icon 503 in FIG. 5) appear on the websites. Again, the user can simply bookmark the address and save it on his local device layer bookmark list for further use, or subscribe to the AR service by clicking on the AR feed icon, etc. In this embodiment, the user may be equipped with a generic AR browser 107b in addition to a standard web browser 107a. In this case the user may access the AR feed by clicking on the feed icon on the website presented to the user via the standard web browser 107a or the user may start the generic AR browser 107b to see a list of the available AR layers that the user has subscribed to via the standard browser 107a.

In another embodiment, the UE 101 can be equipped with a generic AR browser 107b, (e.g., Mozilla AR browser, Opera AR browser, Nokia AR browser, etc.), that can bring generic AR layers directly from standard websites to the UE 101 without initial access to a standard browser 107a. In this embodiment, there will be no need for limiting a UE 101 and a content provider 111a-111n to proprietary solutions (such as Layar, Wikitude or Point & Find) that proxy traffic via their own servers, thereby increasing scalability and reducing resources associated with maintain such centralized servers. In this scenario, the interaction does not start from a standard web browser 107a, but the user directly opens the generic AR browser 107b (for example with the camera see-through). The location information manager 103 may enable the generic AR browser 107b to allow the user to directly enter standard URLs of websites or services that provide AR extensions. The user may remember well-known URLs (e.g., www.yelp.com) and type them directly to the generic AR browser 107b in the same way he would have done with a standard web browser 107a.

In yet another embodiment, the user of a UE 101 may access the provided AR content through a general application (not shown) such as, for example, a mapping application, a navigation application, a game application, etc., or a combination thereof.

In another embodiment, the user of UE 101 may be interested in a type of information, for example such as “Restaurant Reviews” but the user may not be aware of any specific related AR layers, and therefore the user will have no bookmarks or subscriptions to any related layers. Also the user may have never heard of a URL address for the AR layer before. In this case the user can open his standard web browser 107a or generic AR browser 107b and simply search for the keywords “Restaurant Reviews”, via his favourite web search engine.

In one embodiment, the user's client device UE 101 is “AR enabled”, meaning that it has capability to recognize content providers 111a-111n that provide AR layers (e.g., identified via a standardized format for advertising location-based information such as header extensions and the like). An AR enabled UE 101 may alert the search engine about its AR capabilities, for example via a predefined HTTP header such as, “Accept/Content-Type: application/arml+xml”. Additionally, the search engine may also be optimized for AR layer searches. In this case, the search engine returns search results as it normally does, however, it associate higher ranks to the results with advertised AR content and may also show, for instance, a specific icon next to the link presented on the user interface of UE 101 to indicate the availability of AR information.

In one embodiment, clicking on the AR specific icon by the user of UE 101 may automatically activate a generic AR browser 107b in a camera see-through view, and the activated AR browser 107b may fetch or subscribe to the respective AR layer directly from the respective web site and present it to the user.

In one embodiment, the location processing client 109 fetches the respective AR layer from a resource location associated with a content provider 111a-111n. In this embodiment, the location processing client 109 may receive information about the location of the AR enhanced XML resource (e.g., Atom or ARML) from the location information manager 103. Subsequently, the location processing client 109 can make a request to get the AR layer from the resource, for example via a standard HTTP GET command, GET http://www.yelp.com/arml.xml.

However, this request is very generic, as the server may not know what data should be specifically returned (e.g., out of all the global restaurant reviews available). In augmented reality, it is important that the location processing client 109 can pass the location of UE 101 to the location information manager 103. In one embodiment, the location processing client 109 may simply use an extended form of the HTTP request that includes a predetermined format for passing location information, for example, GET http://www.yelp.com/arml.xml?lat=61.506517 & lon=23.746719. In this example, parameters “lan” and “lon” represent the latitude and longitude of the current location of UE 101. Upon receiving the command, the location information manager 103 can filter the search results and return only the content that is visible in the AR view of UE 101.

In another embodiment, the location processing client 109 may utilize a location Application Programming Interface (API), such as, for example, Geolocation, etc., for enhancements of the HTML command. In other embodiments, if the UE 101 is equipped with GPS services, the exact UE location can be easily retrieved from the AR browsers 107a or 107b and passed to the location information manager 103. Alternatively, the AR browsers 107a or a 107b may pass other parameters to the website, based on some predetermined format, for example adding some extra keywords or query to the HTML command that may help the location information manager 103 to filter the search results even further. For example, the command, GET http://www.yelp.com/arml.xml?q=sushi can limit the search result for restaurant reviews only to Sushi restaurants. In this case the AR browsers 107a or 107b can prompt the user of the UE 101 for input regarding the filtering criteria and relay the input to the location information manager 103 to be utilized for filtering of the search result.

In one embodiment, when advertising an AR layer by a content provider 111a-111n, the content provider may also advertise (e.g., in an XML format) the different parameters it supports, and instruct (in a declarative UI fashion) the AR browser 107a or 107b on how to display those optional parameters to the user (e.g., a drop-down list of the different restaurant types).

In one embodiment the standards database 113 may contain formats and regulations that are agreed upon to be utilized for providing the predetermined formats for presenting search parameters, location information, web content, filtering parameters, etc.

By way of example, the UE 101 and the location information manager 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

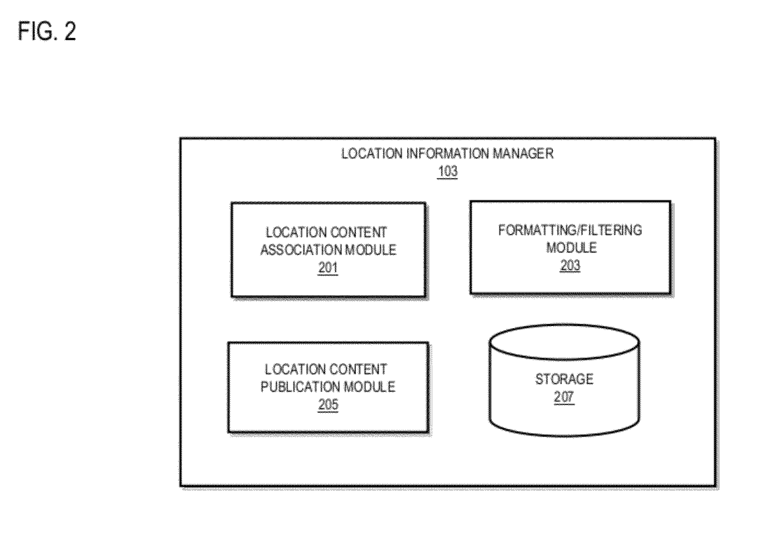

FIG. 2 is a diagram of the components of location information manager, according to one embodiment. By way of example, the location information manager includes one or more components for providing location based information according to a predetermined format. It is contemplated that the functions of these components may be combined in one or more components or performed by other components of equivalent functionality. In this embodiment, the location information manager includes a location content association module 201, a formatting/filtering module 203, a location content publication module 205, and a storage 207.

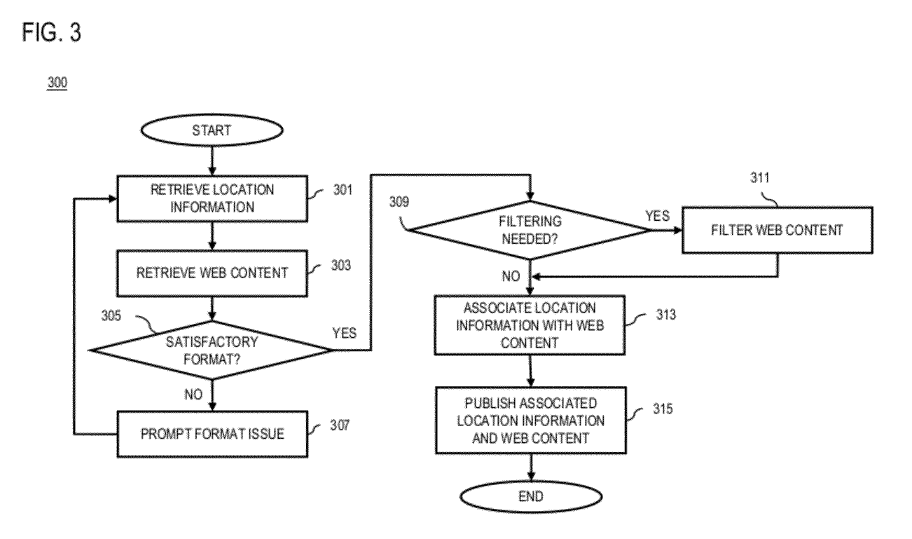

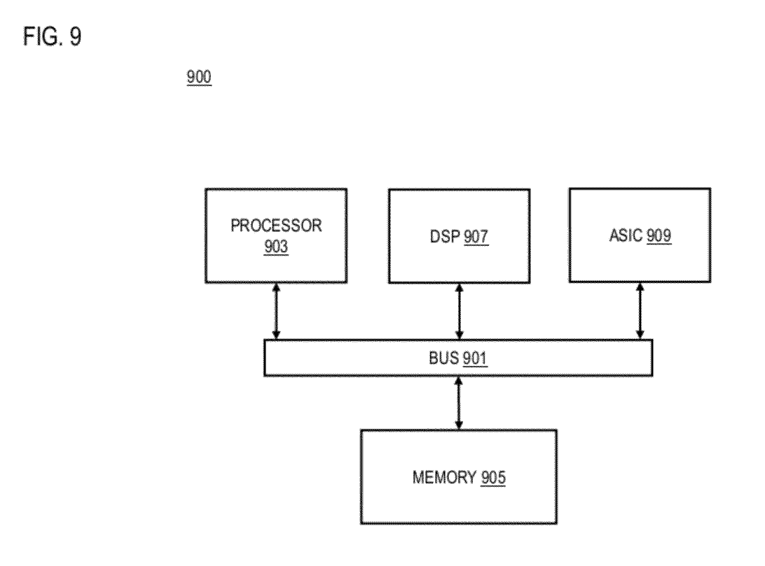

FIG. 2 is described with reference to FIG. 3, wherein FIG. 3 is a flowchart of a process for providing location based information according to a predetermined format, according to one embodiment. In one embodiment, the location information manager 103 performs the process 300 and is implemented in, for instance, a chip set including a processor and a memory as shown in FIG. 9.

In one embodiment, in step 301, the location content association module 201 of the location information manager 103 retrieves information regarding the current location of UE 101. The location information may include latitude and longitude of the UE location, a live image (view) provided by a camera attached to the UE, etc. It is noted that the location content association module 201 may utilize the retrieved information to calculate the direction to which the camera is facing. The location content association module 201 may also receive a request provided by the user of UE 101 describing the type of information the user is looking for.

In one embodiment, the user of UE 101 may have subscriptions to one or more AR providers to automatically receive updated AR feeds. In this embodiment, the content association module 201 may retrieve user's desired information from the list of user's subscription saved on a local storage on UE 101 (not shown).

In other embodiments, as discussed above with regards to FIG. 1, the UE 101 location, the user request, or any other data provided via the UE 101 to the location information manager 103 may be entered by the user as an extended HTTP command including specific parameters, provided by the user, by clicking on an icon provided on the UE 101's browser 107a or 107b screen, etc. or a combination thereof.

Per step 303, the location content association module 201, retrieves web content related to the retrieved request from the content providers 111a-111n via the communication network 105. In one embodiment, the content providers 111a-111n may have previously advertised their available contents to the location information manager 103. The location information manager 103 may store the advertised contents in the storage 207 for further access.

In one embodiment, per step 305, the formatting/filtering module 203 verifies whether the format of retrieved information complies with a predetermined format for indicating location-based information or the availability of location-based information. The predetermined format may include, at least in part, one or more standards-compliant extensions to the web content, wherein the standards-compliant extensions are based, at least in part, on one or more syndication protocols. The formatting/filtering module 203 may retrieve information about the predetermined format from standards database 113 or from local storage 207. If the content format does not comply with the predetermined format, per step 307 the formatting/filtering module 203 may prompt the content providers 111a-111n that the format of provided content is not satisfactory and request the content provider 111a-111n to fix the formatting issue.

In another embodiment, the formatting/filtering module 203 may update the content format without communication with the content providers 111a-111n. For example, the formatting/filtering module 203 may do so based on previous agreements with the content providers 111a-111n in which the content providers may have authorized the location information manager 103 to update information formats.

In yet another embodiment, the location information manager 103 may enable the user of UE 101 to utilize a search engine to parse the location information based, at least in part, on a predetermined format. The search engine may present a list of content providers 111a-111n to the user that provides the requested types of content (e.g., restaurant, library, gas station, etc.)

If the content formats comply with the predetermined formats, per step 309 the formatting/filtering module 203 checks whether the initial request from the user of UE 101 includes any filters. Additionally, the formatting/filtering module 203 may verify the filtering requirement of the content based, at least in part; on visibility of the location information associated with the web content with respect to the one or more general browsers 107a or AR browsers 107b. For example, a filter may identify a user's request to receive content for seafood restaurants from among the list of restaurants. If one or more filters are provided by the user, or by the browser 107a or 107b, per step 311 the formatting/filtering module 203 filters the retrieved web content and produces the final result of user's requested content. The formatting/filtering module 203 may store the result in storage 207.

Per step 313, the location content association module 201 associates the results with the UE 101's location information. In various embodiments, the association between the location and content may be done by generating links between the records of information in a database, by storing the combined location and content information into a specifically designed data structure, a combination thereof, or any other available methods of information linkage.

Per step 315, the location content publication module 205 publishes the web content and associated location information to the UE 101. In one embodiment, a general browser 107a or a generic AR browser 107b of the UE 101 may receive the published content and location information and render the published information to the user of UE 101. In other embodiments, one or more other applications, such as for example games, may render the content and location information based on compliance with one or more of the standard predetermined formats.

In one embodiment, a location processing client 109 may act as an interface between one or more browsers 107a or 107b or one or more other rendering applications and the location information manager 103. The location processing client 109 may facilitate rendering of the web content by the one or more browsers 107 or 107b to include at least one indicator of the location information. By way of example, the indicator may be a symbol, an icon, a link, or any combination thereof to emphasize the location related nature of the content to the user.

Additionally, one or more interaction with the at least one indicator, for example user clicking on the provided icon, may initiate a subscription of the location information. It is noted that in addition to Augmented Reality (AR) information, the content information may include augmented virtual reality, mapping information, navigation information, or any other types of information that may be associated with location or a combination thereof. Furthermore, as previously discussed, the UE 101 may access the provided content through a general application such as, for example, a mapping application, a navigation application (e.g. GPS), a game application, etc., or a combination thereof.

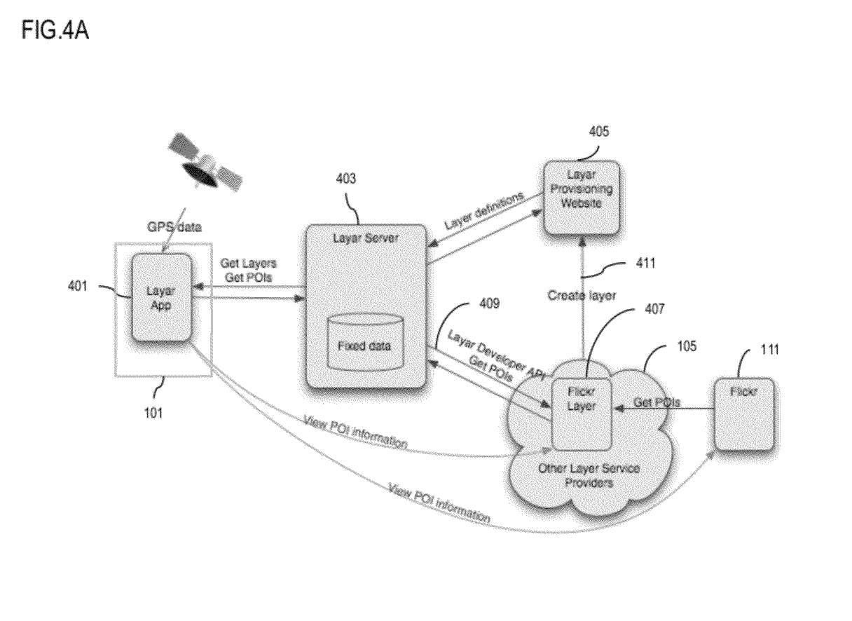

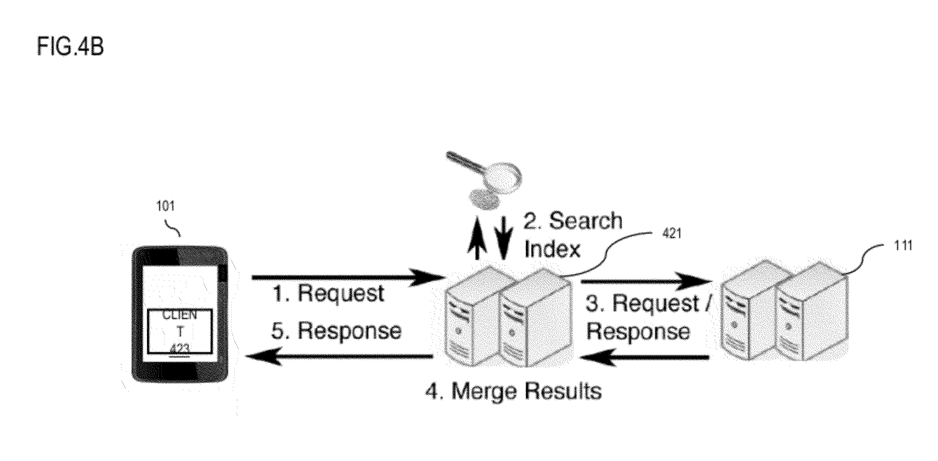

FIGS. 4A-4B show architectures of exemplary location based information providers, according to one embodiment. Typically, filtering of content in AR view is done with the notion of “layers” or “worlds”. As previously discussed, augmented reality browsers such as 107a or 107b allow a user of UE 101 to select the layers or world” of information they are interested in (e.g., “ATMs”, “Real Estate”, etc.) and display only the content related to identified layers to the user. Traditionally, content providers 111a-111n who need to present their content to the users have to do so via one or more augmented reality systems, such as Layar®, Wikitude®, Nokia Point&Find®, etc. It is noted that generally these traditional approaches rely on a proprietary end-to-end AR browser/server system. Therefore, under the traditional approaches, content providers 111a-111n push their data/worlds/layers to Layar, Wikitude, Point&Find, or other servers in order to be able to provide their contents to the users. Additionally, users generally need to have the specific (Layar, Wikitude, Point&Find, other) AR browsers or client applications installed on their UEs 101, which in turn access the data from the respective servers of those systems. In the example of FIG. 4A, the UE 101 is accessing content provided by provider 111 via the Layar system. As shown in FIG. 4A, in order to gain access to content 111, the UE 101 installs and executes the Layar application 401. Furthermore, any communication between the UE 101 and provider 111 occurs through the communication network 105 via the Layar server 403, wherein the Layar server 403 further communicates with the Layar provisioning website 405 for definitions and directions.

In this example, there is no generic AR browser, as there is for the normal web. Under this example of a traditional approach to providing AR information, the users of Layar application 401 are bound to one AR provider, and the Layar application 401 cannot be used to browse non-Layar provided information. Furthermore, because of the lack of interoperability between different AR providers, content providers 111a-111n need to publish their content (world/layer) to multiple solutions or AR services (e.g., to all of Wikitude, Layer, Nokia Point & Find, others), in order to make sure that the content is accessible by as many potential users as possible. Additionally, in traditional systems there is no standard way or predetermined format for publishing the content, as each system uses its own specific format which may not necessarily be compatible with formats used by other systems. It is also noted that the content is always proxied via the server 403 of the specific system/solution (e.g., Layar, Wikitude, etc.) and therefore, long term scalability is not guaranteed.

In the exemplary architecture of FIG. 4A (e.g., used by traditional AR providers such as Layar), a content provider 111 can keep its content on its own server, and instead provide a web API 407 which Layar server 403 can call (arrow 409) when requesting the content. The content provider 111 can also use the management portal 405 of Layar to register a new layer or content (arrow 411).

In one embodiment, the AR browser 401 communicates to the Layar server 403 and shows the available layers to the user. Once the user selects the desired layers, the Layar server 403 proxies the requests further to the web server of the content provider 111 in a dynamic manner for getting the desired content. Typically a request would include the location (latitude, longitude) of the client 401 so that the web service knows where the user is and what content is relevant to serve for that location and for that specific layer. However, all the requests need to go through the Layar Server 403, and the user needs to have the specific Layar browser 401.

FIG. 4B shows another exemplary architecture which is used by Wikitude system. This architecture is similar to the architecture of FIG. 4A with the difference that it allows content providers 111 to upload their content at bulk, for example in Keyhole Markup Language (KML) format, Augmented Reality Markup Language (ARML) format, etc. to the Wikitude servers 421, so that Wikitude client 423 can directly access the content from servers 421. In this case, the content providers 111 do not have to host their own remote servers. However this approach does not solve any of the issues discussed above with regards to FIG. 4A, since UEs 101 would still need to have system specific browsers and content providers 111 are still required to post content to multiple servers. Furthermore, the scalability issue still exists since content is located at a centralized location.

Other exemplary architectures exist, for example the architecture used by Nokia Point&Find, which is similar to the pattern of FIG. 4B where content providers 111 need to upload their content to the system servers 421 via a management portal. The client/browser 423 accesses the content from the server 421.

FIG. 5 shows the representation of a site indicator for a location based information provider on a web browser, according to one embodiment. As shown in FIG. 5, the location information manager 103 provides browser 107 with information about an AR layer and browser 107 presents the information to the UE 101 by reference to an indicator 505 on display 501 similar to reference to a web feed 503, wherein the indicator 505 carries AR specific information provided to the location information manager 103 by a content provider 111 (referred to as logo here). As an example, assuming that the content provider 111 (logo) adds the following header to its website: <link href=“/ar.atom” rel=“alternate” title=“AR view” type=“application/atom+xml+ae> In this example Atom protocol with AR extensions is used. Alternatively, the ARML protocol may be used: <link href=“/arml.xml” rel=“alternate” title=“AR view” type=“application/arml+xml”>

In one embodiment, a web browser 107a, 107b or any other application (e.g., a search engine crawler) receive information about content provider (logo) via the location information manager 103. The information may indicate that the site at www.logo.com supports AR extensions to expose, for instance, an AR layer/world associated with the site or the site's content. In this case, the browser 107 displays indicator 505 next to the logo site address in order to inform user of AR content. By clicking on indicator 505, the user of UE 101 initiates UE 101's subscription to the AR content provided by logo and the message 507 is presented to the user by the browser 107, after the subscription process is successfully completed.

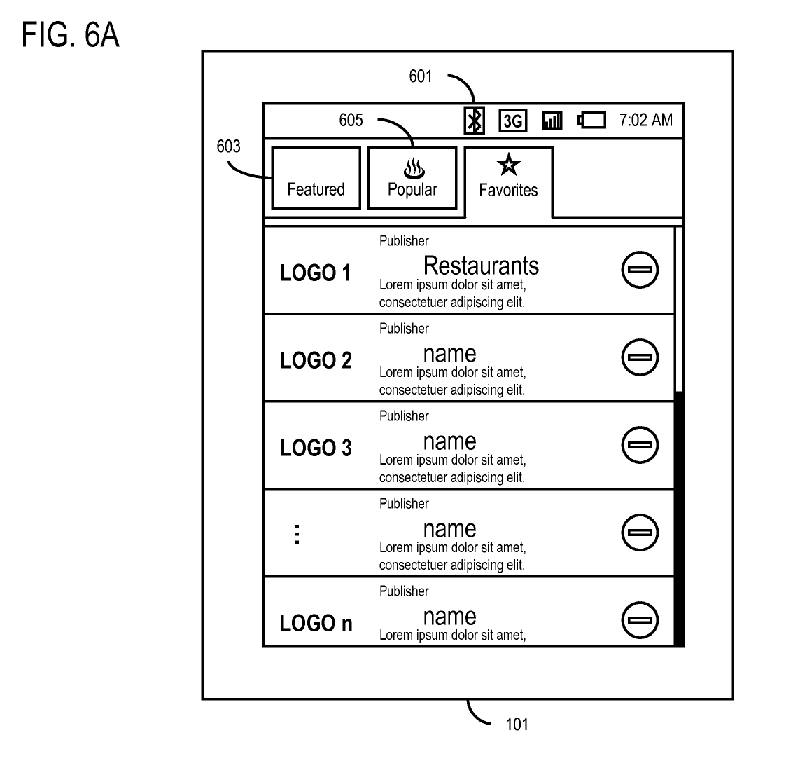

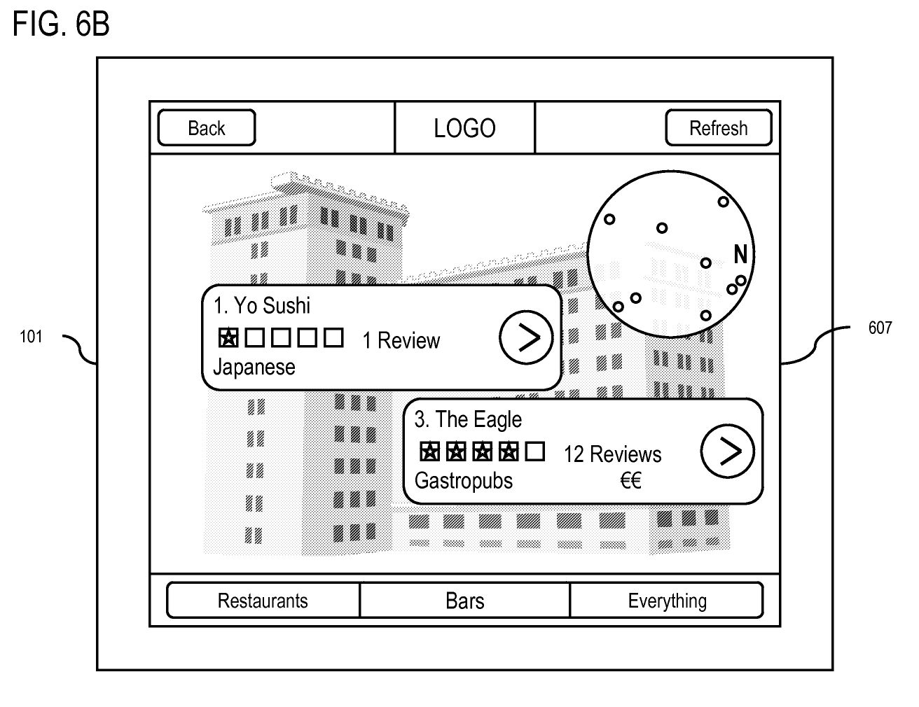

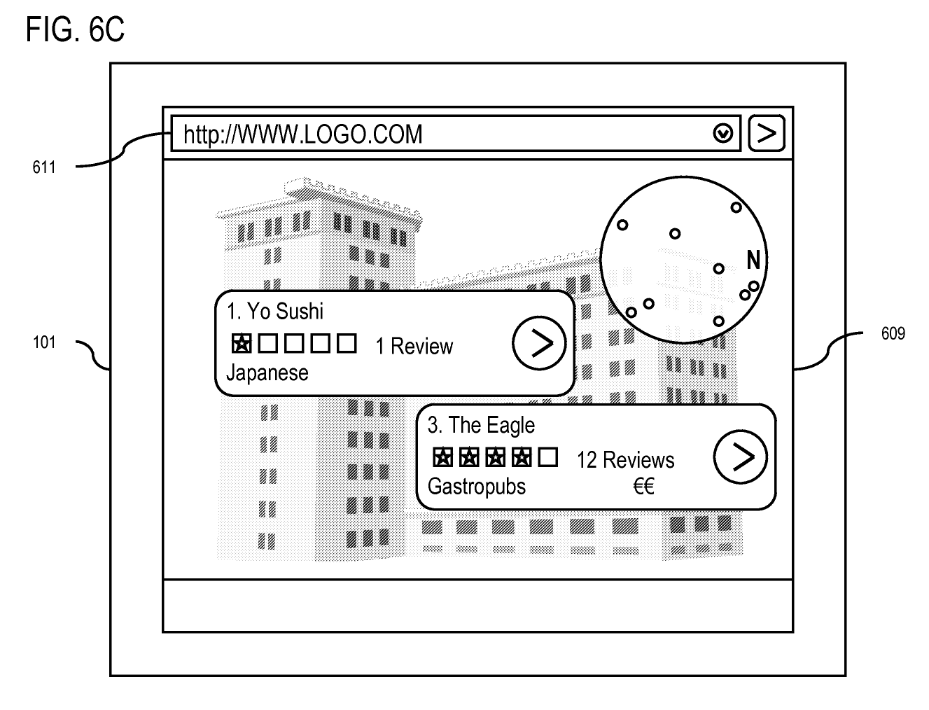

FIGS. 6A-6C show displaying of location based information layers and content on a device screen, according to one embodiment. FIG. 6A shows display of a list of favorite AR providers to the user of UE 101 in display 601. The user may select various options to, for example, see a complete list of featured AR content providers, by clicking on tab 603, see a list of popular AR content providers by clicking on tab 605, etc. Each list may include information about the AR content providers such as a link to the provider's site (LOGO1, LOGO2, . . . , LOGO n), information about the type of content provided (e.g., restaurants), etc.

In one embodiment, user of UE 101 by clicking on one of the links (LOGO1, LOGO2, . . . , LOGO n) activates the camera see-through view seen in FIG. 6B. A general browser 107a may then communicate with the provider 111 site, via the location information manager 103 and based on the Atom/ARML links provided when the layer was bookmarked, for getting the relevant information. As shown in FIG. 6B, the visualization may simply look like a typical AR view. In FIG. 6B the display 607 on UE 101 shows information provided from site LOGO associated with the view from UE 101's camera.

In another embodiment, as shown in FIG. 6C, the interaction among a UE 101 and the content provider 111 via a location information manager 103 does not start from a standard web browser, but the user directly opens a generic AR browser 107b with the camera see-through. The generic AR browser 107b allows the user to directly enter standard URLs of web sites services associated with content providers 111, shown in block 611 in display 609. The user may have memorized URLs of well-known or previously used content providers (e.g., www.logo.com) and by entering the URL address in block 611, the user may directly access the related site in a way similar to a standard web browser.

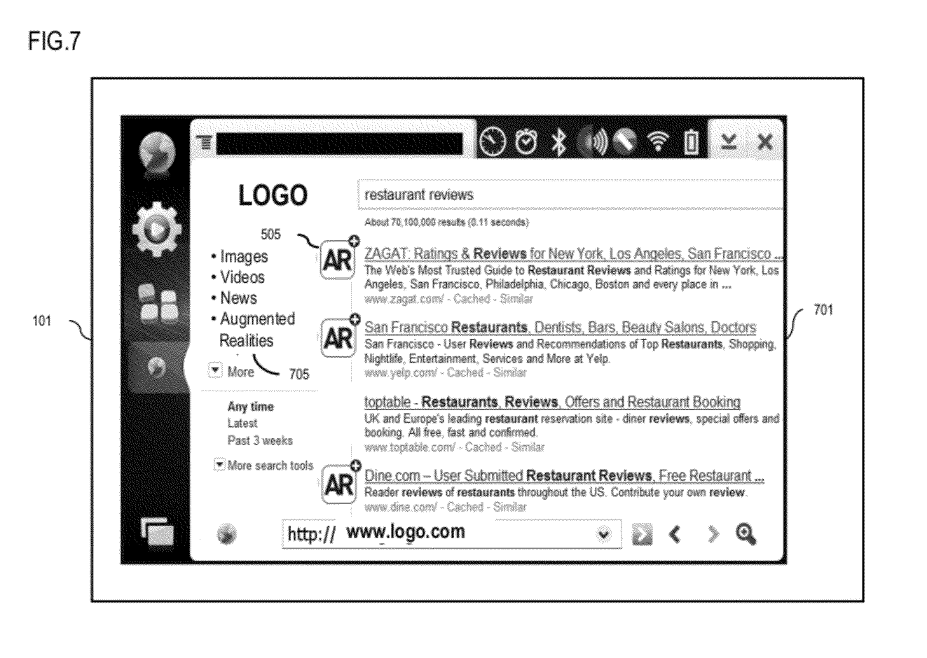

FIG. 7 shows results of a search for location based information providers, according to one embodiment. In one embodiment, the user may not have any previous information about specific content providers or AR layers, and therefore the user does not have access to any bookmarks or previous subscriptions. In this embodiment, the user of UE 101 can activate a standard web browser 107a, or generic AR browser 107b and simply search for keywords related to the desired content (e.g., “Restaurant Reviews”) using a search engine such as Google, Bing, etc. (shown as LOGO). Display 701 in FIG. 7 shows the search results provided by the search engine LOGO. As shown in FIG. 7, since the UE 101 is “AR enabled”, it passes the search information to the search engine (e.g., via predefined HTTP header such as “Accept/Content-Type: application/arml+xml”).

In one embodiment, the search engine LOGO may have been optimized for AR layer searches and able to return the list of search results as any other search. However, the search engine may assign a higher rank to web pages that have advertised their AR content, as described before. The search engine may also display the indicator 505 next to the links with AR content to differentiate them from other sites that although contain information related to the search phrase but do not provide AR content. The user of UE 101 can start a generic AR browser in a camera see-through view (similar to FIG. 6B) by clicking on the links (or indicators 503) in the search result. Upon the clicking on the link by the user, the location information manager 103 can fetch the respective AR layer directly from the respective web site of the content provider 111 and display to the user similar to FIGS. 6B and 6C.

In one embodiment, the optimized search engine may provide a search option such as option 703 for searching only for content providers with AR content. The user can click on option 703 and view only the search results with indicator 505 on the screen.

The processes described herein for providing location based information according to a predetermined format may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

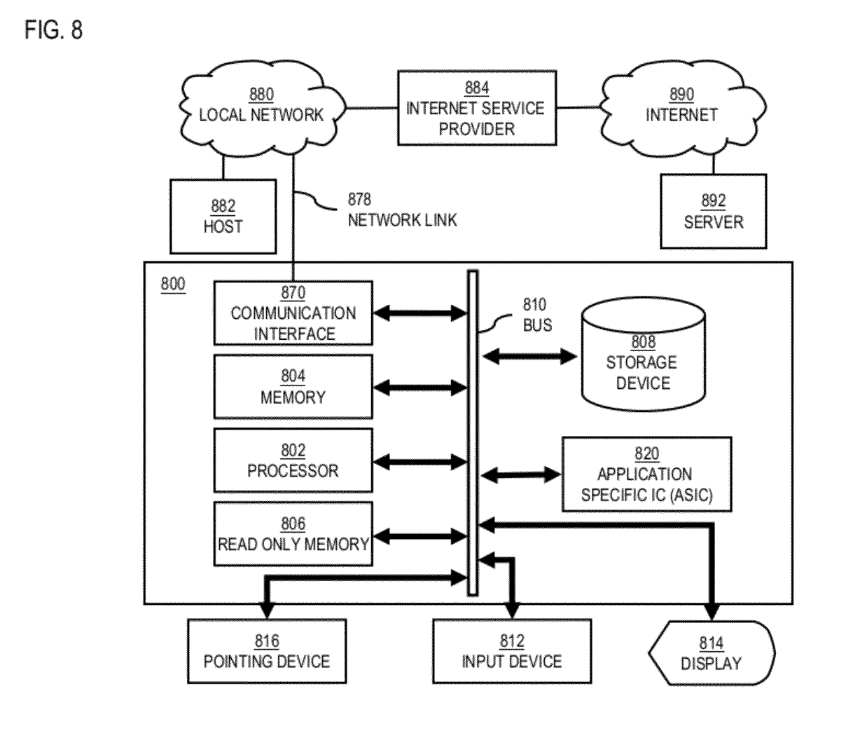

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide location based information according to a predetermined format as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing location based information according to a predetermined format.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to providing location based information according to a predetermined format. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for providing location based information according to a predetermined format. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing location based information according to a predetermined format, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for providing location based information according to a predetermined format to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to provide location based information according to a predetermined format as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of providing location based information according to a predetermined format.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide location based information according to a predetermined format. The memory 905 also stores the data associated with or generated by the execution of the inventive steps.

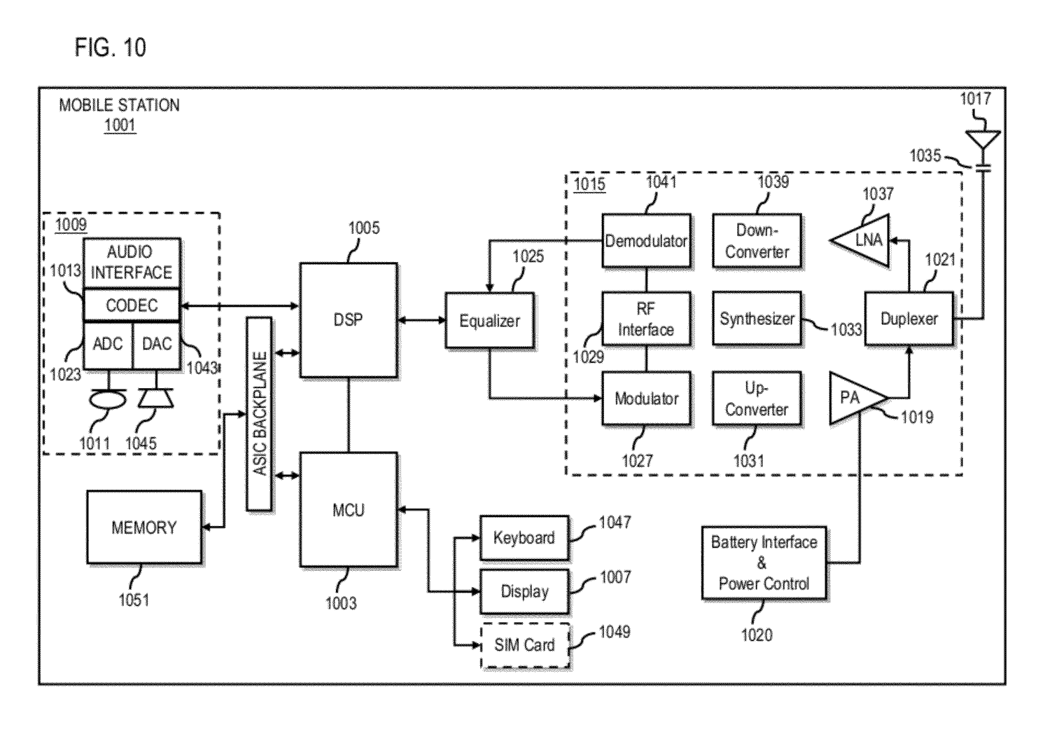

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of providing location based information according to a predetermined format. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing location based information according to a predetermined format. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide location based information according to a predetermined format. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one association of location information with web content; and
at least one publication of the web content and the associated location information according to a predetermined format,
wherein the predetermined format facilitates, at least in part, discovery of the location information.

2. A method of claim 1, wherein the location information includes, at least in part, augmented reality information, augmented virtual reality information, mapping information, navigation information, or a combination thereof.

3. A method of claim 1, wherein the discovery of the location information is performed, at least in part, by one or more general applications, one or more general browser applications, one or more general augmented reality browser applications, or a combination thereof.

4. A method of claim 3, wherein the web content is filtered based, at least in part, on visibility of the location information associated with the web content with respect to the one or more general applications, the one or more general browser applications, the one or more general augmented reality browser applications, or a combination thereof.

5. A method of claim 1, wherein the predetermined format includes, at least in part, one or more standards-compliant extensions to the web content.

6. A method of claim 5, wherein the standards-compliant extensions are based, at least in part, on one or more syndication protocols.

7. A method of claim 3, wherein the one or more general applications, the one or more general browser applications, the one or more general augmented reality applications, or a combination thereof cause, at least in part, rendering of the web content to include at least one indicator of the location information.

8. A method of claim 1, wherein one or more interactions with the at least one indicator initiates a subscription of the location information.

9. A method of claim 1, wherein one or more search engines parse the location information based, at least in part, on the predetermined format.

10. A method of claim 1, wherein the location information is rendered by one or more other applications.

11. An apparatus comprising:
at least one processor; and
at least one memory including computer program code for one or more programs,
the at least one memory and the computer program code configured to, with the at least one processor, cause the apparatus to perform at least the following,
associate location information with web content; and
cause, at least in part, publication of the web content and the associated location information according to a predetermined format,
wherein the predetermined format facilitates, at least in part, discovery of the location information.

12. An apparatus of claim 11, wherein the location information includes, at least in part, augmented reality information, augmented virtual reality information, mapping information, navigation information, or a combination thereof.

13. An apparatus of claim 11, wherein the discovery of the location information is performed, at least in part, by one or more general applications, one or more general browser applications, one or more general augmented reality browser applications, or a combination thereof.

14. An apparatus of claim 13, wherein the web content is filtered based, at least in part, on visibility of the location information associated with the web content with respect to the one or more general applications, the one or more general browser applications, the one or more general augmented reality browser applications, or a combination thereof.

15. An apparatus of claim 11, wherein the predetermined format includes, at least in part, one or more standards-compliant extensions to the web content.

16. An apparatus of claim 15, wherein the standards-compliant extensions are based, at least in part, on one or more syndication protocols.

17. An apparatus of claim 13, wherein the one or more general applications, the one or more general browser applications, the one or more general augmented reality applications, or a combination thereof cause, at least in part, rendering of the web content to include at least one indicator of the location information.

18. An apparatus of claim 11, wherein one or more interactions with the at least one indicator initiates a subscription of the location information.

19. An apparatus of claim 11, wherein one or more search engines parse the location information based, at least in part, on the predetermined format.

20. An apparatus of claim 11, wherein the location information is rendered by one or more other applications.

21.-48. (canceled)
